(19) United States
(12) Patent Application Publication
(10) Pub. No.: US 2014/0022774 A1
(43) Pub. Date: Jan. 23, 2014

(54) Decorative Candle Wrapper

(71) Applicant: Lisa Marie Eastman, Santa Rosa, CA (US)

(72) Inventor: Lisa Marie Eastman, Santa Rosa, CA (US)

(21) Appl. No.: 14/035,169

(22) Filed: Sep. 24, 2013

(51) Int. Cl. F21V 99/00; B32B 38/10

(52) U.S. Cl. CPC F21V 99/00; B32B 38/10
USPC 362/190; 428/195.1; 156/249

(57) ABSTRACT

A kit for the decoration of an imitation candle which includes a removable, replaceable, and reusable decorative wrapper which adheres to the surface of the candle and is translucent such that the glow of the imitation candle enhances the decorative design. The kit optionally includes an imitation candle and/or a holder for decorative wrappers that are not in use.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to the decorative arts. More specifically, the present invention relates to a customizable, removable, replaceable, and reusable, decorative wrapper for an imitation candle.

2. Description of the Related Art

The use of traditional candles as a decorative item is quite common. They provide a gentle glow and are easily replaced with different designs, colors or logos based on seasons, holidays, or events. Traditional candles, however, have the drawback that they are consumed through use, can result in problems with melted wax on furniture or tablecloths, and are inherently dangerous due to the open flame.

Imitation or “flameless” candles are becoming increasingly popular as a safe and attractive alternative to the traditional candle. There are many imitation candles commercially available that provide the glow of a real candle without the problems associated with melting wax or the danger of fire. These candles are available in many colors and with various decorations appropriate for traditional seasons and events. In addition, imitation candles that have replaceable batteries or power cords can be used for many years. The drawback of these products is that they are generally more expensive than a traditional wax candle due to the electronics, and, if they have decoration, the decoration is either embedded in, printed directly on, or permanently attached to the body of the candle. To change the candles displayed in the various seasons, requires a multitude of candles that must be purchased, moved, stored and protected. For the user who desires the warm glow and decorative touch of many candles, this can become burdensome and quite expensive.

The present invention seeks to address these issues by providing a wrapper for an imitation candle which may be decorated in any number of ways based on the preference of the user. The wrapper may be easily removed and replaced with another design at any time. This eliminates the need for, and expense of, multiple imitation candles.

A discussion of the related art of which the present inventor is aware, and its differences and distinctions from the present invention, is provided below.

U.S. Pat. Nos. 8,007,144, 7,967,484, and 7,695,171 disclose various embodiments of an external sleeve for an electronic candle that is customizable for memorial and funerary businesses. These assemblies, however, are quite complex, in that the sleeve is held in place by external mechanical attachments and include springs, and a special base for retention. By contrast, the present invention provides a simple solution that does not require additional, potentially expensive, hardware. In addition, in the prior patented designs, the sleeve does not cover the entire exterior of the candle for a full decorative effect as is provided by the present invention.

Similarly, U.S. Pat. No. 6,800,167 discloses a printing system for generating personalized memorial items, which include candles. Although this system and method allows customization by printing specific designs, the customized element is permanently attached to the memorial item. It is not replaceable, and, again, would not cover the entire exterior of the candle for a full decorative effect.

U.S. Pat. Nos. 7,934,845, 7,178,939, and 6,616,308 all disclose decorative devices for imitation candles, but none are removable and replaceable.

U.S. Patent Application No. 20100046240 discloses a Decorative Sleeve for a flameless candle that is removable. The sleeve, however, is made from a material, or assembly of materials, that is formed into a cylinder and then slid over the outside of the flameless candle. The method of forming the cylinder requires an overlap of the material, such that a thickened section, or seam, is created on the cylinder. In addition, to allow the sleeve to slide over the outside of the candle, the inner diameter of the cylindrical sleeve must exceed that of the candle, resulting in a visual gap at the top of the candle. The seam and the gap created by the sleeve both serve to defeat the decorative purpose by appearing merely as a covering of the candle, and not as an integral element of the candle.

The present invention seeks to address these issues by providing a wrapper which covers the entire outer diameter of the candle, and actually adheres to the surface of the candle. The visual effect is that the candle appears to be specifically designed for the season or event. The wrapper is easily removed and replaced with another design at any time, by simply peeling the wrapper off the candle and replacing it with a new one more suited to the season or to the user's current decorative scheme.

### BRIEF SUMMARY OF THE INVENTION

The object of the present invention is a kit which includes at least one inexpensive and easily removable and replaceable decorative candle wrapper that adheres to the candle such that it appears to be an integral part of the candle. The kit may also include one or more storage sheets that hold the wrappers when not in use, and/or one or more imitation candles.

In its uninstalled state, the wrapper consists of a pre-sized, flat piece of peel and stick removable fabric or paper material. The wrapper is sized such that it covers the entire outer vertical surface of a commercially available imitation candle.

The wrapper is decorated via printing or other means prior to installation on the candle, either by the manufacturer, or by the end user. The removable backing of the material is peeled off by the user and discarded. The user then attaches the adhesive side of the wrapper to the candle such that it covers the entire outer vertical surface. The material is preferably somewhat translucent to allow the gentle glow of the candle to illuminate the design and provide the decorative warmth of a traditional glowing candle.

When the user desires a different design on the candle, they simply peel the wrapper off the candle and place it on a storage sheet. A new wrapper is then installed on the candle to create the desired decorative effect.

### BRIEF DESCRIPTION OF THE SEVERAL VIEWS OF THE DRAWINGS

A more complete understanding of the present invention may be derived by referring to the detailed description and claims when considered in connection with the figures, wherein like reference numbers refer to similar items throughout the figures and:

FIG. 1 is a perspective view of a cylindrical imitation candle with a decorative wrapper installed, and wherein, for illustrative purposes, the decoration is shown as a whimsical tree design.

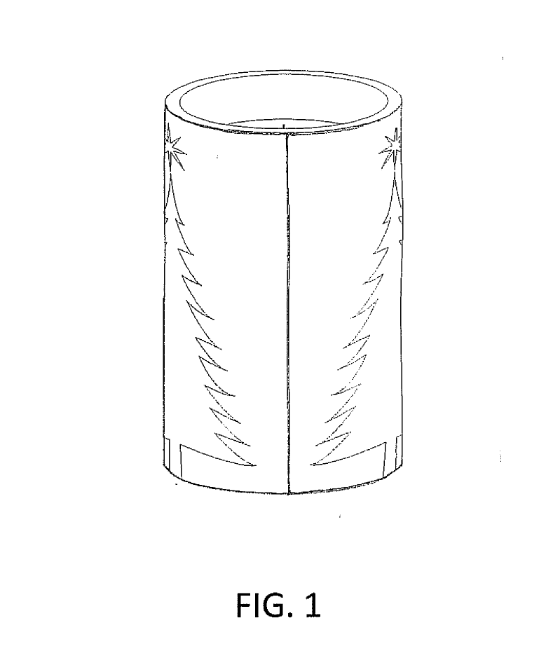

FIG. 2 shows is a perspective view of the cylindrical imitation candle and wrapper shown in FIG. 1 with a portion of the decorative wrapper peeled back from the imitation candle.

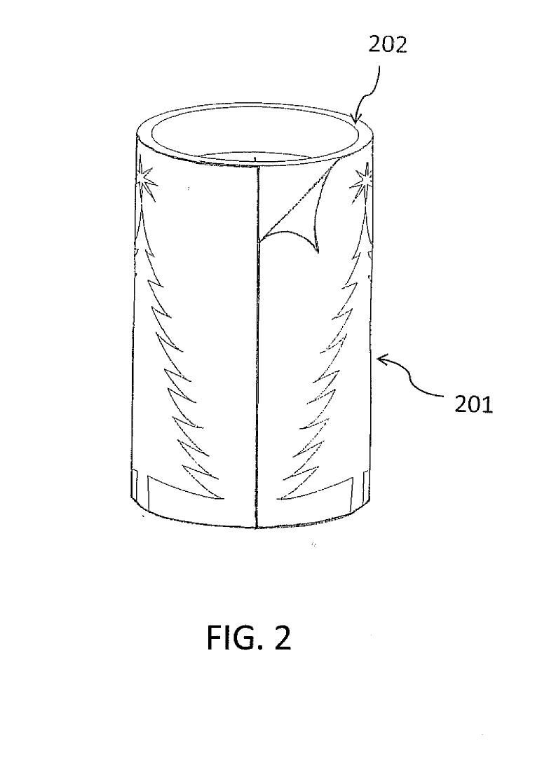

FIG. 3 shows a wrapper storage sheet with a decorative wrapper placed on it, and with one corner of the decorative wrapper peeled back for illustrative purposes.

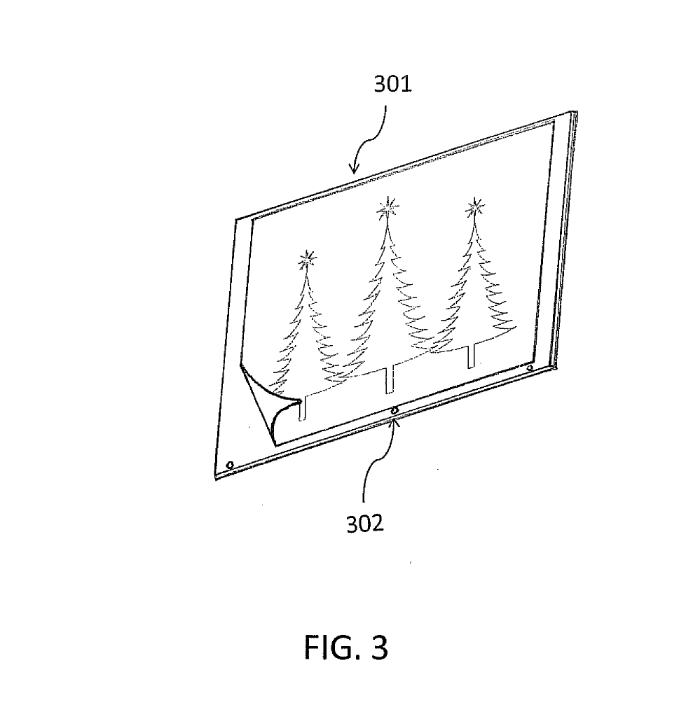

FIG. 4 shows a wrapper sheet suitable for a home printer that has the wrapper pre-cut within the sheet.

### DETAILED DESCRIPTION OF THE INVENTION

In the following detailed description of the invention, reference is made to the accompanying drawings which form a part of the disclosure and, which show by way of illustration, and not of limitation, specific embodiments by which the invention may be practiced. The drawings, the foregoing discussion, and the following description are exemplary and explanatory only, and are not intended to limit the scope of the invention or its application in any manner.

The wrapper 201 consists of a piece of peel and stick removable fabric or paper material. The material may be selected from any of the commercially available removable materials that are generally used for decorating walls or providing means for replaceable advertising and are sold under brand names such as Photo Tex. The material is preferably translucent such that the glow of an imitation candle 202 can be seen through the wrapper 201 when it is installed on a candle 202. The material may also be flame retardant or flame resistant for added safety. In a preferred embodiment, the material has a removable backing (not shown) that is peeled off and discarded, and the adhesive under the removable backing is sufficient to adhere to the exterior of an imitation candle 202, but not so strong as to cause permanent attachment.

The wrapper 201 is pre-cut to size such that its size matches the outer vertical surface of the commercially available imitation candle 202. The user removes the removable backing (not shown) from the wrapper 201 to expose the adhesive layer, and applies the wrapper 201 to the candle 202 such that it covers the entire vertical exterior. Because the wrapper material is removable, the user may peel the wrapper off the candle and re-apply to ensure exact positioning of the wrapper for proper positioning on the candle exterior.

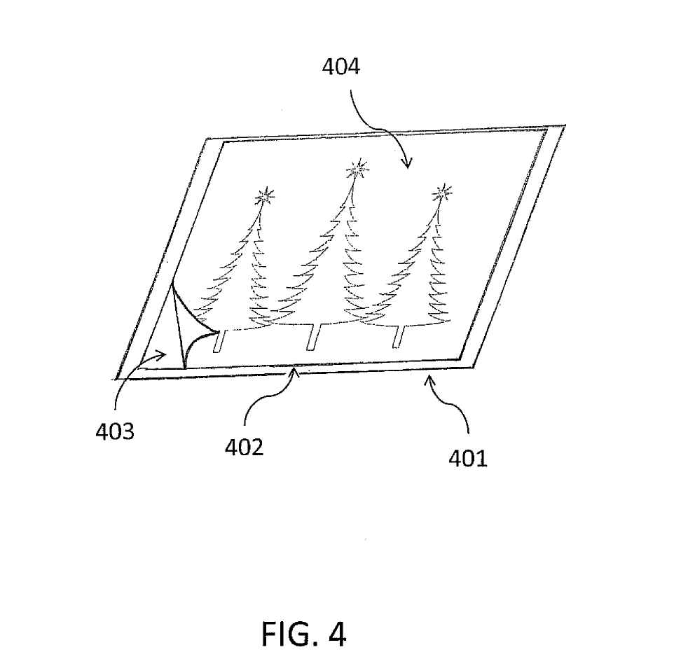

In an alternate embodiment, and as illustrated in FIG. 4, a decorated or undecorated sheet of wrapper material 401 that is sized to fit a standard home printer is provided to the end user. In that embodiment, the wrapper material is cut to the proper size for use with the candle 202. The cut 402 extends only through the wrapper material and does not extend through the removable backing material 403, so that the entire sheet may be processed through a home laser, ink-jet or other printer. After processing through the home printer, or adding decoration by other means, the user peels only the pre-cut wrapper portion 404 from the backing and installs the wrapper portion 404 on the candle.

The wrapper kit may include an optional storage sheet 301 that consists of a flat piece of material that is at least the size of the wrapper 201 when laid flat. The storage sheet 301 is made from PVC or other commercially available material that has a surface suitable for adherence of the wrapper 201. When the user desires to change the appearance of a candle that has a wrapper 201 already installed, the user peels the existing wrapper 201 from the candle 202 and places it, adhesive side down, on the storage sheet 301. Because the wrapper adhesive is designed to allow the wrapper material to be attached and removed repeatedly, there is no or only minimal degradation to the adhering properties of the wrapper 201, and it may later be unpeeled from the storage sheet 301 and re-installed on the candle 202. In a preferred embodiment, the storage sheet 301 has been pre-punched with 3 holes 302 suitably spaced for installation in a standard 3-ring binder. In a preferred embodiment, the storage sheet 301 is flat so that it may be stacked on other storage sheets with other un-used wrappers to facilitate storage.

In an alternate embodiment, the kit also includes one or more imitation candles 202 and the wrappers 201 are particularly sized for the included candle(s). In this embodiment, one of the wrappers 201 may be pre-installed on the imitation candle(s) 202 by the manufacturer.

In yet another alternate embodiment (not shown), the kit consists of one or more candles 202 that has more than one wrapper 201 that is pre-installed in layers on the candle(s). In this embodiment, the manufacturer installs wrappers 201 that are designed in size to be layered on top of each other such that each successive wrapper is slightly larger in width to accommodate the prior wrapper. When the user desires a change from the outer-most design, they simply peel off the outermost layer to reveal a new design. In this embodiment, the designs are preferably artistically chosen such that the decoration on the inner layer(s) when seen through the installed outer layers provides a cohesive design. In this embodiment, optional storage sheets may also be provided so that the user may store the removed wrappers and reassemble all the wrappers on the candle for repeated cycling through the candle designs.

Many modifications and variations of this invention may be made without departing from its spirit and scope, as will be appreciated by those skilled in the art. For example, the wrappers may be sized to cover imitation candles that are not cylindrical in shape, they may be designed to cover only a portion of the candle for artistic effect, or they may be made from peel and stick removable material that has decorative elements of metallic flakes, reflective paint, heat sensitive colorings, or other special effects for artistic and decorative purposes. The specific embodiments described herein are offered by way of example only. The embodiments were chosen and described in order to best explain the principles of the invention and its practiced applications.

I claim:

1. A candle decorating kit comprising at least one candle wrapper, wherein said wrapper in its uninstalled state is a flat rectangular piece made from peel and stick removable fabric or paper material that is pre-cut to size to match the external dimensions of the vertical portion of an imitation candle, and wherein the material is preferably translucent and decorated in a manner such that the light emitting from the imitation candle passes through the wrapper when installed on the candle and serves to accentuate the decoration.

2. The candle decorating kit of claim 1, further comprising at least one storage sheet consisting of a preferably flat plate made from PVC or similar material that allows adherence of the wrapper and subsequent removal of the wrapper and whose dimensions are at least the size of the wrapper(s).

3. The candle decorating kit of claim 1, further comprising at least one imitation candle.

4. The candle decorating kit of claim 2, further comprising at least one imitation candle.

5. A candle decorating kit comprising at least one customizable candle wrapper sheet, wherein said wrapper sheet in its uninstalled state is a flat rectangular piece made from decorated or undecorated peel and stick removable fabric or paper material that is of suitable size for printing on a home printer, and wherein the material is pre-cut through only the fabric or paper, and not through the peelable backing material, to allow removal of a wrapper that matches the external dimensions of the vertical portion of an imitation candle, and wherein the material is preferably translucent in a manner such that the light emitting from the imitation candle passes through the wrapper when installed on the candle and serves to accentuate any decoration on the material.

6. The candle decorating kit of claim 5, further comprising at least one storage sheet consisting of a preferably flat plate made from PVC or similar material that allow adherence of the wrapper and subsequent removal of the wrapper and whose dimensions are at least the size of the wrapper(s).

7. The candle decorating kit of claim 5, further comprising at least one imitation candle.

8. The candle decorating kit of claim 6, further comprising at least one imitation candle.

9. A decorated candle comprising an imitation candle that has at least one wrapper pre-installed on the exterior vertical surface of the candle, wherein the wrapper is made from peel and stick removable fabric or paper material that is preferably translucent and decorated in a manner such that the light emitting from the imitation candle passes through the wrapper when installed on the candle and serves to accentuate the decoration.

10. A candle kit comprising the decorated candle of claim 9 wherein at least two wrappers are installed in layers on the exterior of the candle and wherein they are decorated such that designs on the layers are artistically chosen to create a cohesive design, and outer layer(s) may be removed to reveal a unique design.

11. The candle kit of claim 10 further comprising a sufficient number of storage sheets to store the removed wrapper(s), and wherein the wrapper holder(s) consist of a preferably flat plate made from PVC or similar material that allow adherence of the wrapper and subsequent removal of the wrapper and whose dimensions are larger than the wrapper(s).

12. A process for decorating an imitation candle comprising the steps of: a. Removing the protecting backing from a wrapper consisting of a pre-sized and decorated piece of peel and stick removable fabric or paper; b. Placing the wrapper on an imitation candle such that it covers the entire vertical exterior; c. Removing the wrapper by peeling it off the imitation candle; d. Storing the wrapper for later use by installing it on a holder; e. Repeating step a. with a different decorated piece of peel and stick removable fabric or paper.
